(19) United States
(12) Patent Application Publication
(10) Pub. No.: US 2026/0187504 A1
(43) Pub. Date: Jul. 2, 2026

(54) EVALUATING FINE-TUNING OF MACHINE LEARNING MODELS BASED ON TRAINING DATA DISTRIBUTIONS

(71) Applicant: INTERNATIONAL BUSINESS MACHINES CORPORATION, ARMONK, NY (US)

(72) Inventors: ZHONG FANG YUAN, XIAN (CN); TONG LIU, XIAN (CN); HAECHUL SHIN, DURHAM, NC (US); GENNARO ANTHONY CUOMO, RALEIGH, NC (US); LUCIA LARISE STAVARACHE, COLUMBUS, OH (US)

(21) Appl. No.: 19/007,664

(22) Filed: Jan. 2, 2025

(51) Int. Cl. G06N 7/00

(52) U.S. Cl. CPC G06N 7/00

(57) ABSTRACT

Evaluating fine-tuning of machine learning models based on training data distributions, includes: generating a first Gaussian mixture model based on a vector embedding of a training data set used to train a machine learning model; generating a second Gaussian mixture model based on a vector embedding of an updated training data set for the machine learning model, wherein the vector embedding of the updated training data set comprises the vector embedding of the training data set and a vector embedding of additional training data; and fine-tuning the machine learning model using the additional training data based on a comparison of multiple parameters of the first Gaussian mixture model to multiple parameters of the second Gaussian mixture model.

### BACKGROUND

The present disclosure relates to machine learning models, training machine learning models, user interaction with the training of machine learning models, and automated recognition of need for fine-tuning a machine learning model.

### SUMMARY

According to embodiments of the present disclosure, various methods, systems and products for evaluating fine-tuning of machine learning models based on training data distributions are described herein. In some aspects, evaluating fine-tuning of machine learning models based on training data distributions includes generating a first Gaussian mixture model based on a vector embedding of a training data set used to train a machine learning model; generating a second Gaussian mixture model based on a vector embedding of an updated training data set for the machine learning model, wherein the vector embedding of the updated training data set comprises the vector embedding of the training data set and a vector embedding of additional training data; and fine-tuning the machine learning model using the additional training data based on a comparison of multiple parameters of the first Gaussian mixture model to multiple parameters of the second Gaussian mixture model. In some aspects, a computer system may include a processor set; one or more computer-readable storage media; and program instructions stored on the one or more storage media to cause the processor set to perform operations comprising this method. In some aspects, a computer program product may include: one or more computer readable storage media; and program instructions stored on the one or more storage media to perform operations comprising this method.

### BRIEF DESCRIPTION OF THE DRAWINGS

FIG. 1 sets forth a block diagram of an example computing environment for evaluating fine-tuning of machine learning models based on training data distributions in accordance with some embodiments of the present disclosure.

FIG. 2 sets forth an example timeline of training data accumulation in accordance with some embodiments of the present disclosure.

FIG. 3 sets forth a portion of a process flow for evaluating fine-tuning of machine learning models based on training data distributions in accordance with the present disclosure.

FIG. 4 sets forth an example diagram of generating derivative vectors for evaluating fine-tuning of machine learning models based on training data distributions in accordance with some embodiments of the present disclosure.

FIG. 5 illustrates an example diagram of generating a Gaussian mixture model for evaluating fine-tuning of machine learning models based on training data distributions in accordance with some embodiments of the present disclosure.

FIG. 6 shows an example mapping of a Gaussian mixture model to a chromatograph for evaluating fine-tuning of machine learning models based on training data distributions in accordance with some embodiments of the present disclosure.

FIG. 7 sets forth a flowchart of an example method for evaluating fine-tuning of machine learning models based on training data distributions in accordance with some embodiments of the present disclosure.

FIG. 8 sets forth a flowchart of another example method for evaluating fine-tuning of machine learning models based on training data distributions in accordance with some embodiments of the present disclosure.

FIG. 9 sets forth a flowchart of another example method for evaluating fine-tuning of machine learning models based on training data distributions in accordance with some embodiments of the present disclosure.

FIG. 10 sets forth a flowchart of another example method for evaluating fine-tuning of machine learning models based on training data distributions in accordance with some embodiments of the present disclosure.

FIG. 11 sets forth a flowchart of another example method for evaluating fine-tuning of machine learning models based on training data distributions in accordance with some embodiments of the present disclosure.

FIG. 12 sets forth a flowchart of another example method for evaluating fine-tuning of machine learning models based on training data distributions in accordance with some embodiments of the present disclosure.

### DETAILED DESCRIPTION

In some aspects, a computer-implemented method for evaluating fine-tuning of machine learning models based on training data distributions includes: generating a first Gaussian mixture model based on a vector embedding of a training data set used to train a machine learning model; generating a second Gaussian mixture model based on a vector embedding of an updated training data set for the machine learning model, wherein the vector embedding of the updated training data set comprises the vector embedding of the training data set and a vector embedding of additional training data; and fine-tuning the machine learning model using the additional training data based on a comparison of multiple parameters of the first Gaussian mixture model to multiple parameters of the second Gaussian mixture model. This provides the technical advantage of using the parameters of Gaussian mixture models as a basis of comparison for training data sets to determine if a machine learning model should be fine-tuned, improving the utility of the machine learning model while optimizing resource utilization.

In some aspects, the computer-implemented method also includes: generating the vector embedding of the training data set by providing the training data set to an encoder of the machine learning model; and generating the vector embedding of the additional training data by providing the additional training data to the encoder of the machine learning model. This provides the technical advantage of mapping data to points in a multidimensional space, allowing these points to be used in generating the Gaussian mixture models, improving system utility.

In some aspects, the computer-implemented method also includes: generating, based on the training data set, a derivative vector embedding of the training data set by generating, for each sample of the training data set, multiple first derivative vectors; generating, based on the additional training data, a derivative vector embedding of the additional training data by generating, for each sample of the additional training data, multiple second derivative vectors; and wherein the first Gaussian mixture model is based on the derivative vector embedding of the training data set and the second Gaussian mixture model is based on a derivative vector embedding of the updated training data set comprising the derivative vector embedding of the training data set and the derivative vector embedding of the additional training data. This provides the technical advantage of adding density to the set of points used to generate the Gaussian mixture model, improving the efficiency of mixture model generation and the quality and accuracy of the resulting mixture models, improving system utility and performance.

In some aspects, generating, for each sample of the training data set, multiple first derivative vectors comprises repeatedly providing each sample of the training data set to a different randomly modified version of a neural network used to generate the vector embedding of the training data set; and generating, for each sample of the additional training data, multiple second derivative vectors comprises repeatedly providing each sample of the additional training data to the different randomly modified version of the neural network. This provides the technical advantage of generating derivative vectors similar, but not identical, to the vector generated from the same data sample, thereby making the vector and associated derivative vectors consistent in multidimensional space, improving system utility and performance.

In some aspects, the multiple parameters of the first Gaussian mixture model and the multiple parameters of the second Gaussian mixture model each comprise: corresponding multiple means, corresponding multiple covariance matrices, or corresponding multiple mixture coefficients. This provides the technical advantage of allowing for Gaussian mixture models to be compared using multiple different parameters, improving system utility and performance.

In some aspects, fine-tuning the machine learning model using the additional training data based on the comparison of the multiple parameters of the first Gaussian mixture model to the multiple parameters of the second Gaussian mixture model comprises determining that a degree of change between the multiple parameters of the first Gaussian mixture model and the multiple parameters of the second Gaussian mixture model exceeds a threshold. This provides the technical advantage of initiating automatic fine-tuning of the machine learning model where the difference in compared parameters exceeds some defined threshold, preventing unnecessary fine-tuning of the machine learning model, improving system utility and performance.

In some aspects, fine-tuning the machine learning model using the additional training data based on the comparison of the multiple parameters of the first Gaussian mixture model to the multiple parameters of the second Gaussian mixture model includes: providing, to a user, a visualization of a degree of change between the multiple parameters of the first Gaussian mixture model and the multiple parameters of the second Gaussian mixture model; and receiving, from the user, a request to fine-tune the machine learning model. This provides the advantage of allowing for user determinations as to when to fine-tune a model using an easily understandable visualization, improving the user experience and improving system utility and performance.

In some aspects, a computer system for evaluating fine-tuning of machine learning models based on training data distributions includes: a processor set; one or more computer-readable storage media; and program instructions stored on the one or more storage media to cause the processor set to perform operations including: generating a first Gaussian mixture model based on a vector embedding of a training data set used to train a machine learning model; generating a second Gaussian mixture model based on a vector embedding of an updated training data set for the machine learning model, wherein the vector embedding of the updated training data set comprises the vector embedding of the training data set and a vector embedding of additional training data; and fine-tuning the machine learning model using the additional training data based on a comparison of multiple parameters of the first Gaussian mixture model to multiple parameters of the second Gaussian mixture model. This provides the advantage of using the parameters of Gaussian mixture models as a basis of comparison for training data sets to determine if a machine learning model should be fine-tuned, improving the utility of the machine learning model while optimizing resource utilization.

In some aspects, the operations also include: generating the vector embedding of the training data set by providing the training data set to an encoder of the machine learning model; and generating the vector embedding of the additional training data by providing the additional training data to the encoder of the machine learning model. This provides the technical advantage of mapping data to points in a multidimensional space, allowing these points to be used in generating the Gaussian mixture models, improving system utility.

In some aspects, the operations also include: generating, based on the training data set, a derivative vector embedding of the training data set by generating, for each sample of the training data set, multiple first derivative vectors; generating, based on the additional training data, a derivative vector embedding of the additional training data by generating, for each sample of the additional training data, multiple second derivative vectors; and wherein the first Gaussian mixture model is based on the derivative vector embedding of the training data set and the second Gaussian mixture model is based on a derivative vector embedding of the updated training data set comprising the derivative vector embedding of the training data set and the derivative vector embedding of the additional training data. This provides the technical advantage of adding density to the set of points used to generate the Gaussian mixture model, improving the efficiency of mixture model generation and the quality and accuracy of the resulting mixture models, improving system utility and performance.

In some aspects, generating, for each sample of the training data set, multiple first derivative vectors comprises repeatedly providing each sample of the training data set to a different randomly modified version of a neural network used to generate the vector embedding of the training data set; and generating, for each sample of the additional training data, multiple second derivative vectors comprises repeatedly providing each sample of the additional training data to the different randomly modified version of the neural network. This provides the technical advantage of generating derivative vectors similar, but not identical, to the vector generated from the same data sample, thereby making the vector and associated derivative vectors consistent in multidimensional space, improving system utility and performance.

In some aspects, the multiple parameters of the first Gaussian mixture model and the multiple parameters of the second Gaussian mixture model each comprise: corresponding multiple means, corresponding multiple covariance matrices, or corresponding multiple mixture coefficients. This provides the technical advantage of allowing for Gaussian mixture models to be compared using multiple different parameters, improving system utility and performance.

In some aspects, fine-tuning the machine learning model using the additional training data based on the comparison of the multiple parameters of the first Gaussian mixture model to the multiple parameters of the second Gaussian mixture model comprises determining that a degree of change between the multiple parameters of the first Gaussian mixture model and the multiple parameters of the second Gaussian mixture model exceeds a threshold. This provides the technical advantage of initiating automatic fine-tuning of the machine learning model where the difference in compared parameters exceeds some defined threshold, preventing unnecessary fine-tuning of the machine learning model, improving system utility and performance.

In some aspects, fine-tuning the machine learning model using the additional training data based on the comparison of the multiple parameters of the first Gaussian mixture model to the multiple parameters of the second Gaussian mixture model includes: providing, to a user, a visualization of a degree of change between the multiple parameters of the first Gaussian mixture model and the multiple parameters of the second Gaussian mixture model; and receiving, from the user, a request to fine-tune the machine learning model. This provides the advantage of allowing for user determinations as to when to fine-tune a model using an easily understandable visualization, improving the user experience and improving system utility and performance.

In some aspects, a computer program product for evaluating fine-tuning of machine learning models based on training data distributions includes: one or more computer readable storage media; and program instructions stored on the one or more storage media to perform operations including: generating a first Gaussian mixture model based on a vector embedding of a training data set used to train a machine learning model; generating a second Gaussian mixture model based on a vector embedding of an updated training data set for the machine learning model, wherein the vector embedding of the updated training data set comprises the vector embedding of the training data set and a vector embedding of additional training data; and fine-tuning the machine learning model using the additional training data based on a comparison of multiple parameters of the first Gaussian mixture model to multiple parameters of the second Gaussian mixture model. This provides the advantage of using the parameters of Gaussian mixture models as a basis of comparison for training data sets to determine if a machine learning model should be fine-tuned, improving the utility of the machine learning model while optimizing resource utilization.

In some aspects, the operations also include: generating the vector embedding of the training data set by providing the training data set to an encoder of the machine learning model; and generating the vector embedding of the additional training data by providing the additional training data to the encoder of the machine learning model. This provides the technical advantage of mapping data to points in a multidimensional space, allowing these points to be used in generating the Gaussian mixture models, improving system utility.

In some aspects, the operations also include: generating, based on the training data set, a derivative vector embedding of the training data set by generating, for each sample of the training data set, multiple first derivative vectors; generating, based on the additional training data, a derivative vector embedding of the additional training data by generating, for each sample of the additional training data, multiple second derivative vectors; and wherein the first Gaussian mixture model is based on the derivative vector embedding of the training data set and the second Gaussian mixture model is based on a derivative vector embedding of the updated training data set comprising the derivative vector embedding of the training data set and the derivative vector embedding of the additional training data. This provides the technical advantage of adding density to the set of points used to generate the Gaussian mixture model, improving the efficiency of mixture model generation and the quality and accuracy of the resulting mixture models, improving system utility and performance.

In some aspects, generating, for each sample of the training data set, multiple first derivative vectors comprises repeatedly providing each sample of the training data set to a different randomly modified version of a neural network used to generate the vector embedding of the training data set; and generating, for each sample of the additional training data, multiple second derivative vectors comprises repeatedly providing each sample of the additional training data to the different randomly modified version of the neural network. This provides the technical advantage of generating derivative vectors similar, but not identical, to the vector generated from the same data sample, thereby making the vector and associated derivative vectors consistent in multidimensional space, improving system utility and performance.

In some aspects, the multiple parameters of the first Gaussian mixture model and the multiple parameters of the second Gaussian mixture model each comprise: a corresponding multiple means, a corresponding multiple covariance matrices, or a corresponding multiple mixture coefficients. This provides the technical advantage of allowing for Gaussian mixture models to be compared using multiple different parameters, improving system utility and performance.

In some aspects, fine-tuning the machine learning model using the additional training data based on the comparison of the multiple parameters of the first Gaussian mixture model to the multiple parameters of the second Gaussian mixture model comprises determining that a degree of change between the multiple parameters of the first Gaussian mixture model and the multiple parameters of the second Gaussian mixture model exceeds a threshold. This provides the technical advantage of initiating automatic fine-tuning of the machine learning model where the difference in compared parameters exceeds some defined threshold, preventing unnecessary fine-tuning of the machine learning model, improving system utility and performance.

In some aspects, fine-tuning the machine learning model using the additional training data based on the comparison of the multiple parameters of the first Gaussian mixture model to the multiple parameters of the second Gaussian mixture model includes: providing, to a user, a visualization of a degree of change between the multiple parameters of the first Gaussian mixture model and the multiple parameters of the second Gaussian mixture model; and receiving, from the user, a request to fine-tune the machine learning model. This provides the advantage of allowing for user determinations as to when to fine-tune a model using an easily understandable visualization, improving the user experience and improving system utility and performance.

Machine learning models, particularly deep learning models such as large language models (LLMs) or other generative artificial intelligence (AI) models, may be trained using large amounts of training data. After training and deployment, additional training data for the model may be accumulated. Rather than fully retraining the model on the original training data and the additional training data, fine-tuning allows the trained model to be updated using only the additional training data. Both the training and fine-tuning process require significant amounts of time, computational resources, and financial costs.

If this additional training data is too similar to the original training data, the changes to the performance of the model due to fine-tuning may be minimal. Thus, the significant costs and resource expenditures incurred in fine-tuning the model would only result in minimal performance changes, effectively having the costs outweigh the benefits of fine-tuning the model. If fine-tuning is delayed, allowing for further additional training data to be accumulated, this may result in more significant performance changes in the fine-tuned model. However, if fine-tuning is delayed too long the deployed model may lag behind competitors with more recently trained or fine-tuned models. Accordingly, it is beneficial to determine when the model should be fine-tuned so as to achieve a significant enough performance change to justify the costs and resource expenditures without waiting so long as to allow deployed models to lag behind those of competitors.

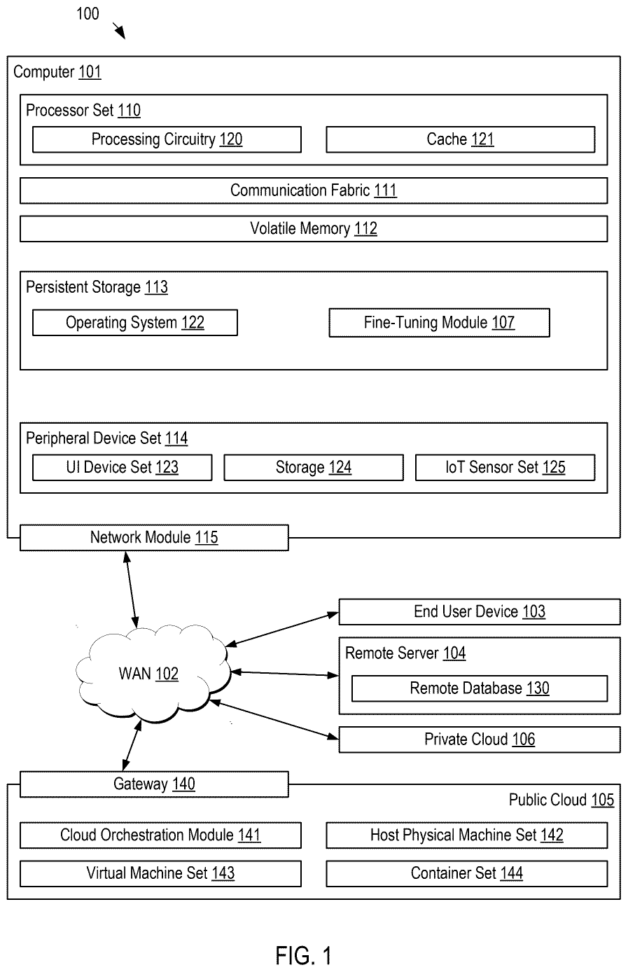

With reference now to FIG. 1, shown is an example computing environment according to aspects of the present disclosure. Computing environment 100 contains an example of an environment for the execution of at least some of the computer code involved in performing the various methods described herein, such as the fine-tuning module 107. In addition to block 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

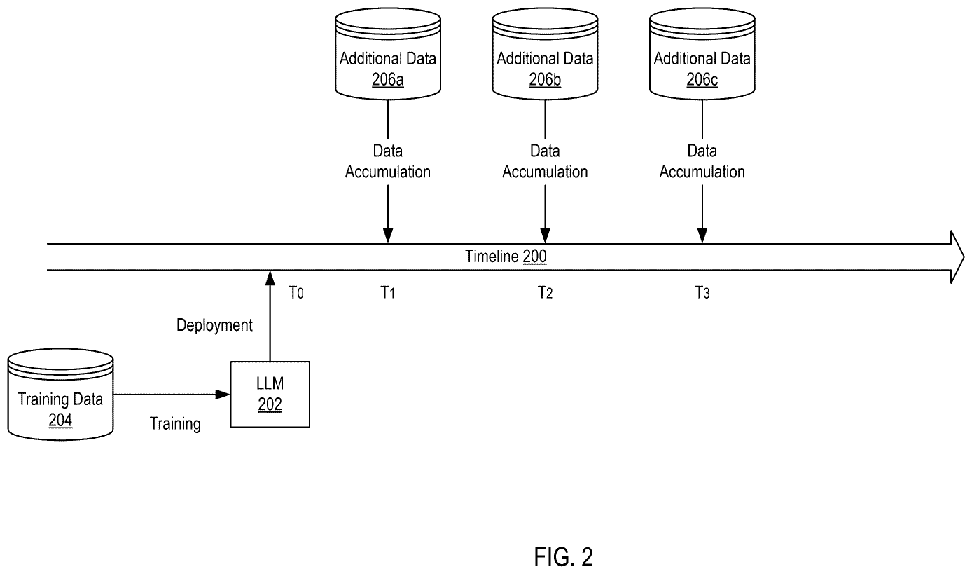

FIG. 2 sets forth an example timeline 200 of training data accumulation in accordance with some embodiments of the present disclosure. At time T0 a machine learning model such as a large language model (LLM) 202 is trained using a set of training data 204 and deployed for use. Although this example timeline 200 is presented in the context of an LLM 202, readers will appreciate that the scenario depicted in this example timeline 200 is applicable to any trained machine learning model. After deployment, at times T1, T2, T3, additional training data for the LLM 202, shown as additional data 206a,b,c, is accumulated. The LLM 202 may be fine-tuned using any of this additional data 206a,b,c after accumulation. As referred to herein, fine-tuning of a machine learning model such as the LLM 202 causes the machine learning model to be updated using additional training data not used in training or fine-tuning the machine learning model in its current state. Readers will appreciate that fine-tuning of a machine learning model is different than training or retraining a machine learning model in that, during training or retraining, a new version or instance of a machine learning model is generated based on a corpus of training data. In contrast, fine-tuning of a machine learning model is an update to an already trained machine learning model using only some amount of additional training data beyond the original corpus of training data. Thus, the fine-tuned machine learning model reflects both the original corpus of training data and the additional training data without requiring a full retraining of the machine learning model. Readers will appreciate that the particular approaches used in fine-tuning a machine learning model may depend on the particular type of machine learning model to be fine-tuned.

Though potentially less than a full training or retraining, fine-tuning a machine learning model nonetheless requires significant amounts of computational resources, time, and money, particularly for deep learning models (e.g., LLMs) trained and/or fine-tuned using large amounts of training data. If fine-tuning of the machine learning model is performed too soon (e.g., after accumulating a comparatively small amount of additional training data), the machine learning model may only receive small changes or improvements in performance. Thus, significant costs may be incurred for minor changes to the machine learning model. If fine-tuning of the machine learning model is performed too late (e.g., after waiting for a comparatively large amount of additional training data), the deployed version of the machine learning model may begin to lag behind competitors trained on more recent or up-to-date data. Accordingly, choosing an optimal time to fine-tune the machine learning model ensures that the costs and resource expenditure used in fine-tuning the model will result in appreciable changes to the machine learning model while not allowing for a deployed version of the machine learning model to grow stale or lag behind competitors.

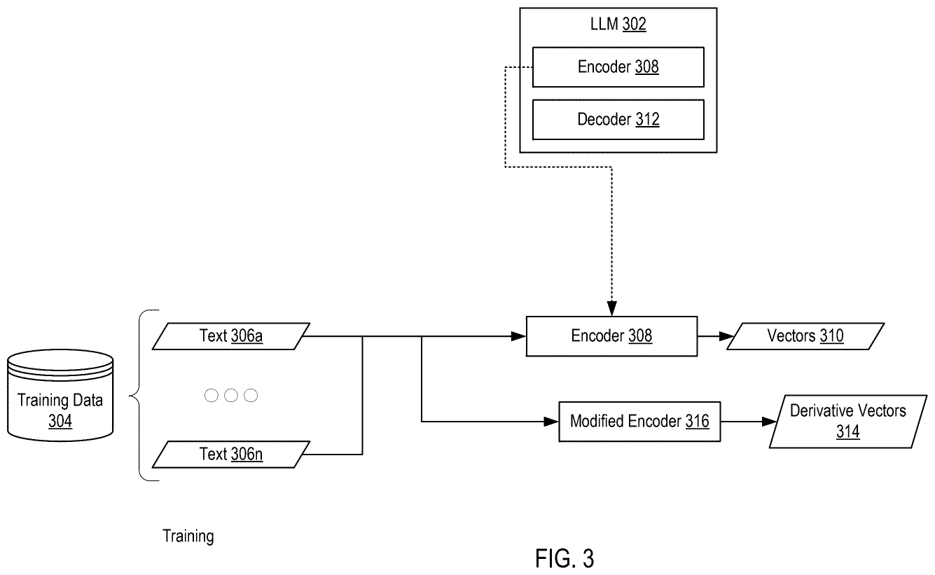

To address these concerns, FIG. 3 sets forth a portion of a process flow for evaluating fine-tuning of machine learning models based on training data distributions in accordance with the present disclosure. In order to evaluate whether a machine learning model should be retrained based on additional training data, the training data used to train the machine learning model is mapped to a multidimensional space. Accordingly, FIG. 3 depicts an LLM 302 trained using a set of training data 304. In some embodiments, this training data 304 may include a corpus of training data 304 used to perform an initial (e.g., full) training of the LLM 302. In some embodiments, the LLM 302 has already been fine-tuned at some point after the initial training. Accordingly, in some embodiments, this training data 304 may include additional training data 304 used to fine-tune the LLM 302 in addition to the corpus of training data 304 used to perform the initial training of the LLM 302. Although the following discussion is presented in the context of an LLM 302, readers will appreciate that this is for illustrative purposes and that the approaches set forth herein may be applied to any trained machine learning model.

Text encodings of each sample of the training data 304 are extracted or generated from the training data 304, shown as text 306a-n. Each sample of text 306a-n is provided as input to an encoder 308 to generate, for each sample, a corresponding vector 310. The corresponding vector 310 for a given sample of text 306a-n is referred to as a vector embedding of that sample. Accordingly, the resulting vectors 310 generated from the training data 304 are hereinafter referred to as a vector embedding of the training data 304. Each vector 310 is a multidimensional data structure with each index storing a numerical value. Thus, the encoder 308 serves to convert text input into a multidimensional vector 310 of numerical values.

For example, in some embodiments, the LLM 302 may be implemented using an encoder-decoder architecture. Readers will appreciate that the encoder-decoder architecture for machine learning models is known in the art and used in various types of trained machine learning models. The encoder-decoder architecture includes two primary components: an encoder 308 and a decoder 312. Both the encoder 308 and the decoder 312 may each be implemented as a trained neural network. For example, both the encoder 308 and the decoder 312 may be implemented as a recurrent neural network, a class of neural network trained for sequential data processing. As is set forth above, the encoder 308 coverts input data such as text into a vector embedding (e.g., a multidimensional vector 310 of numerical values). The decoder 312 accepts and processes the vector embedding of the input from the encoder 308 to generate the output of the machine learning model. As the decoder 312 component is more easily and effectively trained on vector embedding inputs, the encoder 308 allows the machine learning model to accept non-vector inputs and generate a vector embedding usable by the decoder 312 to generate the final output. Both the encoder 308 and decoder 312 components are trained when training the machine learning model.

Accordingly, the encoder 308 of the LLM 302 may be used to generate the vector embedding of the training data 304. As each vector 310 is a multidimensional vector 310 of numerical values, this effectively converts the training data 304 into points in a multidimensional space. As will be described in further detail below, a Gaussian mixture model will be generated from the vector embedding of the training data. In some embodiments, a Gaussian mixture model may be more accurately and efficiently generated from data points more densely populated in the multidimensional space than the initial vector embedding of the training data 304. Accordingly, additional points in the multidimensional space are added in addition to the vector embedding of the training data 304, shown as derivative vectors 314. This effectively converts a single point in multidimensional space to a cluster or distribution of data points in multidimensional space.

A derivative vector 314 is vector based on some sample in the training data 304 that was generated using a modified approach that was used to generate the vector 310. Particularly, derivative vectors 314 may be generated such that the derivative vectors 314 are similar, but not identical, to the vector 310 generated from the same sample of training data 304. In some embodiments, multiple, different derivative vectors 314 may be generated from the sample of training data. The particular number of derivative vectors 314 generated from a vector 310 may include a predefined, configurable, or user-defined parameter that may vary according to particular design or engineering considerations. Particularly, the number of generated derivative vectors 314 may be the same across each vector 310 to prevent unwanted variations in density across vectors 310 and their derivative vectors 314 that may skew the subsequently generated Gaussian mixture model.

In some embodiments, generating derivative vectors 314 from a given sample (e.g., a given portion of text 306a-n) may include repeatedly providing the sample to a differently modified version of a neural network used to generate the vector 310. By generating the derivative vectors 314 using a modified version of the neural network used to generate the vector 310, this ensures that the vector 310 and the derivative vectors 310 are consistent in the multidimensional space. For example, where the vector 310 was generated by providing the sample to an encoder 308, derivative vectors 314 may be generated by repeatedly providing the sample to differently modified versions of the encoder 308, shown as the modified encoder 316.

Readers will appreciate that a neural network such as the encoder 308 may be encoded using multiple layers of neurons (e.g., nodes) with these neurons interconnected using neural connections (e.g., edges). For each derivative vector 314 to be generated, neural connections in the encoder 308 may be randomly dropped to generate a modified encoder 316. This causes each derivative vector 314 to be different in that they are generated using a different, random modification of the encoder 308. This produces a “random jitter” effect by producing, for a given sample of training data, multiple derivative vectors 314 that are similar (e.g., spatially proximate) to but different than the corresponding vector 310.

In some embodiments, a predefined, configurable, or user-defined probability threshold may be used in randomly dropping neural connections from the encoder 308 to generate a modified encoder 316. The probability threshold may correspond to an approximate percentage, amount, or number of neural connections to be randomly dropped from the encoder 308. In such embodiments, for each neural connection, a random number may be generated and, if that random number falls below the probability threshold, the neural connection will be dropped. For example, assuming a probability threshold of 0.2, a random number may be generated from zero to one. If that random number falls below 0.2, the corresponding neural connection will be dropped. This may result in a modified neural network with approximately twenty percent of its neural connections randomly dropped. In some embodiments, neurons (e.g., nodes) of encoder 308 may be randomly dropped instead of or in addition to neural connections.

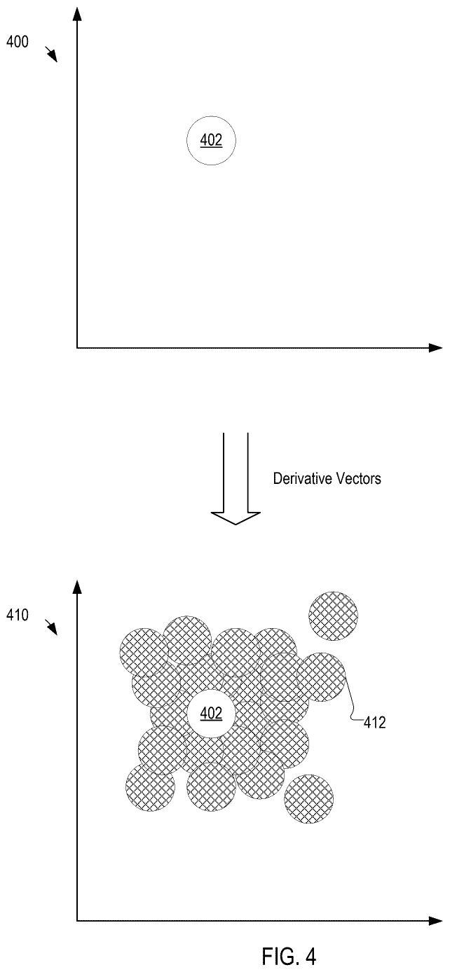

FIG. 4 sets forth an example diagram of generating derivative vectors for evaluating fine-tuning of machine learning models based on training data distributions in accordance with some embodiments of the present disclosure. FIG. 4 includes a graph 400 showing a point representing a vector 402 generated from some sample of training data. Here, the vector 402 is shown as a point in two-dimensional space. Readers will appreciate that this is merely illustrative for clarity and that the approaches set forth herein are applicable to multidimensional spaces having a greater number of dimensions. FIG. 4 also includes a graph 410 reflecting the creation of derivative vectors 412 from the same sample of training data used to generate the vector 402. Here, the graph 410 includes multiple additional points, shown in grey, each corresponding to a derivative vector 412. As shown, the resulting derivative vectors 412 are spatially proximate to but different from the original vector 402. By repeating this process across each sample of the training data, this results in a more highly and densely populated set of points in the multidimensional space compared to the original vector embedding of the training data.

The vector embedding of the training data and the derivative vectors form a set of multidimensional points based on the training data. A Gaussian mixture model may then be generated from this set of multidimensional points. As would be known by one skilled in the art, a Gaussian mixture model is a probabilistic model for identifying and representing normally distributed subpopulations (hereinafter referred to as “components”) within an overall population. Generating a Gaussian mixture model is a form of unsupervised learning whereby, given a defined number of subpopulations, the parameters of the Gaussian mixture model are initialized and iteratively updated using expectation maximization (EM) until the parameters converge. The number of clusters of the Gaussian mixture model is a user-defined hyperparameter that may be determined and set based on particular design and engineering considerations.

The parameters of a Gaussian mixture model include, for each component, a corresponding mean, covariance matrix, and mixture coefficient. In other words, the parameters of a Gaussian mixture model having multiple components includes multiple means, multiple covariance matrices, and multiple mixture coefficients each corresponding to a particular component of the Gaussian mixture model. The mean of a given component is the average of all points in the component. As components are bound or defined using ellipsoids, the covariance matrix of a given component defines the directions and lengths of the axes in the shape of the component. The mixture coefficient of a given component is a weight assigned to each component given the constraint that the sum of mixture coefficients for all components is equal to one.

As would be understood by one skilled in the art, the EM (Expectation-Maximization) algorithm used to generate a Gaussian mixture model includes three steps: an initialization step, followed by repeatedly performing an expectation step and maximization step until the parameters of the Gaussian mixture model converge. The initialization step sets the parameters to initial values. The expectation step includes calculating, given the currently defined parameters, for each data point and component combination, an expectation value representing an expectation that a given data point is included in a given component. The maximization step includes updating the values of the parameters to maximize the expectation values calculated in the expectation step. The expectation and maximization steps are repeatedly performed until the parameters converge. The parameters are deemed to have converged where the difference between the parameters at a given iteration and the parameters at the preceding iteration falls below some tolerance threshold. This difference between parameters may include, for example, calculating the distance between two multidimensional data points each corresponding to a set of parameters. The tolerance threshold includes a predefined, configurable, or user-defined threshold that may be determined based on various design or engineering considerations.

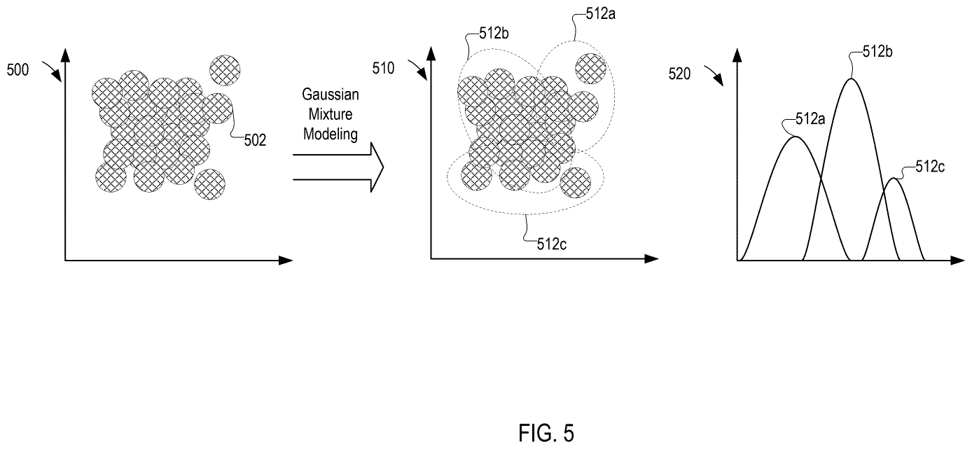

FIG. 5 illustrates an example diagram of generating a Gaussian mixture model for evaluating fine-tuning of machine learning models based on training data distributions in accordance with some embodiments of the present disclosure. FIG. 5 includes a graph 500 showing a set of data points 502. These data points 502 may correspond to a vector embedding of a set of training data and the corresponding derivative vectors. Although these data points 502 are shown in a two-dimensional space, readers will appreciate that this is for illustrative purposes and that the approaches set forth herein are also applicable to other multidimensional spaces. A Gaussian mixture model having three components (e.g., assuming a preset number of three components) is then generated from these data points 502 as shown in graph 510. Graph 510 shows three ellipsoidal components 512a,b,c into which the various data points 502 are assigned. The distribution of the data points 502 in each of these components 512a,b,c are shown in graph 520, showing normal distributions for each component 512a,b,c.

The Gaussian mixture model for the training data of a machine learning model (e.g., the Gaussian mixture model based on the vector embedding of the training data and the associated derivative vectors) may then be used to determine whether the machine learning model should be fine-tuned using some additional training data. To do so, an updated Gaussian mixture model may be generated using similar approaches as are described above applied to the additional training data. For example, a vector embedding for the additional training data may be generated. Derivative vectors may then be generated from the additional training data. The updated Gaussian mixture model may then be generated using a data set including the vector embeddings for both the training data and the additional training data as well as their associated derivative vectors.

This updated Gaussian mixture model will include its own set of parameters as described above. Changes in these parameters compared to those of the original Gaussian mixture model reflect the overall changes between the original training data and updated training data including both the original training data and the additional training data. For example, where the additional training data is highly similar to the original training data, the parameters of the original Gaussian mixture model and the updated Gaussian mixture model may be similar. Conversely, where the original training data is highly dissimilar to the original training data, the parameters of the original Gaussian mixture model and the updated Gaussian mixture model may differ to a greater degree.

Accordingly, in some embodiments, a comparison between the parameters of the original Gaussian mixture model and the updated Gaussian mixture model may be used to determine whether to fine-tune the machine learning model. For example, in some embodiments, a difference between these parameters may be calculated (e.g., by calculating a distance between multidimensional points mapping each set of parameters, or by another approach) and may be calculated to some defined, configurable, or user-defined tolerance threshold. Where this difference exceeds the tolerance threshold, this may indicate that the machine learning model should be fine-tuned using the additional training data. As another example, in some embodiments, each parameter value for the updated Gaussian mixture model may be compared to its corresponding value in the original Gaussian mixture model. Where a change in any of these parameters exceeds some threshold, this may indicate that the machine learning model should be fine-tuned using the additional training data. For example, fine-tuning the machine learning model may be automatically initiated. As another example, a notification or message may be generated (e.g., to a user) indicating that the machine learning model should be fine-tuned.

In some embodiments, differences between the parameters of the original Gaussian mixture model and the updated Gaussian mixture model may be represented using a visualization (e.g., as part of a graphical user interface (GUI)). For example, as is set forth above, the updated Gaussian mixture model may be graphed or represented using a graph of the normal distributions of the components (e.g., graph 520 of FIG. 5). In some embodiments, this visualization may include a chromatograph whereby each of these normal distributions may be assigned (e.g., mapped to) a color representing a degree to which the parameters of their corresponding components differ from their parameters in the original Gaussian mixture model. For example, in some embodiments, the color of a normal distribution may be set from a range of blue to red based on its mean, where blue indicates a mean changing to a lesser degree compared to the original Gaussian mixture model while red indicates a mean changing to a greater degree. As another example, the saturation of the normal distribution may vary based on changes to the corresponding covariance matrix compared to the original Gaussian mixture model. Readers will appreciate that these examples are merely exemplary and that the color or visual attributes of a chromatograph may map in other ways to changes in parameters across Gaussian mixture models. For example, the particular changes in color or visual attributes may be mapped to changes in parameters based on the range and magnitude of the corresponding parameters. Moreover, readers will appreciate that the particular colors used in the chromatogram may be selected based on design or engineering considerations to ensure visually identifiable representations of changes in parameters.

A user presented with this chromatograph is presented with a visual representation of how parameters have changed across Gaussian mixture models. This may allow a user to quickly evaluate whether significant changes in these parameters have occurred. A user may then provide a request (e.g., as a command to the GUI or another interface) to fine-tune the machine learning model.

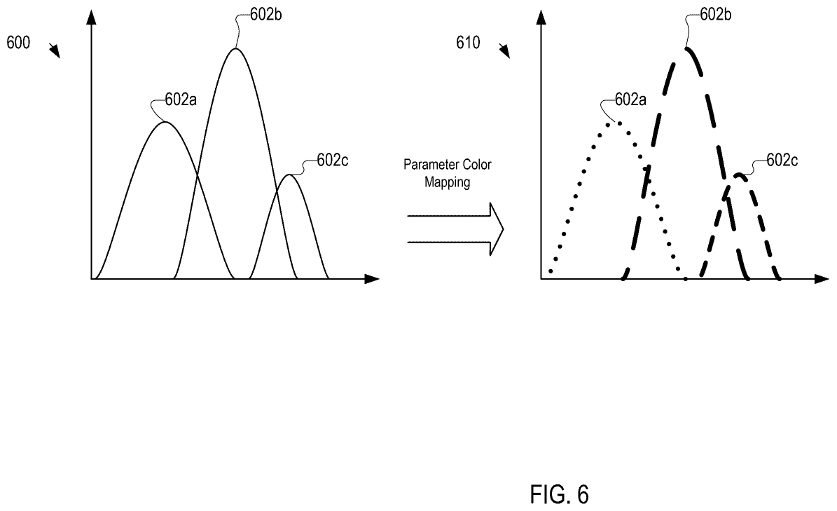

As an example, FIG. 6 shows an example mapping of a Gaussian mixture model to a chromatograph for evaluating fine-tuning of machine learning models based on training data distributions in accordance with some embodiments of the present disclosure. Graph 600 shows the normal distributions for components 602a,b,c of an updated Gaussian mixture model. Graph 610 shows these normal distributions as a chromatograph, with line colors corresponding to a degree of change in a mean of the corresponding components 602a,b,c relative to an original Gaussian mixture model. The chromatograph of graph 610 is shown in greyscale but readers will appreciate that multicolored chromatographs may also be used. In this example, lighter lines represent lesser degrees of change while darker lines represent greater degrees of change in means. Here, the mean of component 602b has experienced a greater degree of change and is shown with the darkest line. The means of components 602a and 602b have experienced lesser degrees of change, shown with comparatively lighter lines.

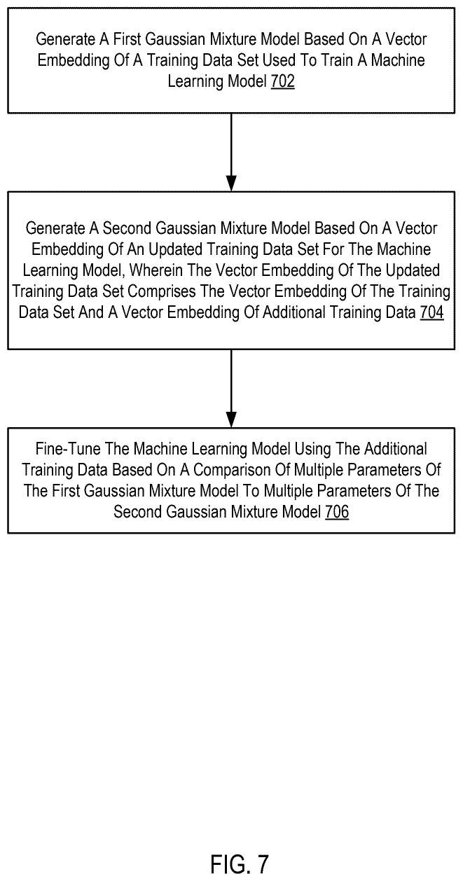

For further explanation, FIG. 7 sets forth a flowchart of an example method of evaluating fine-tuning of machine learning models based on training data distributions in accordance with some embodiments of the present disclosure. The method of FIG. 7 may be performed, for example, using the fine-tuning module 107 of FIG. 1. The method of FIG. 7 includes generating 702 a first Gaussian mixture model based on a vector embedding of a training data set used to train a machine learning model. The vector embedding of the training data set includes a vector representation of each sample in the training data set. Thus, each sample of the training data set may be represented in the vector embedding of the training data set by a multidimensional vector of numerical values. In other words, each sample of the training data set may be represented as a point in multidimensional space. The vector embedding of the training data set may be performed using similar approaches as are set forth above.

The first Gaussian mixture model may then be generated 702 based on a set of multidimension points that includes the vector embedding of the training data set. As will be described in further detail below, this set of multidimensional points may also include derivative vectors generated from the training data set. As is set forth above, generating 702 the first Gaussian mixture model may include applying an EM algorithm to the set of multidimensional points until the parameters of the first Gaussian mixture model converge.

The method of FIG. 7 also includes generating 704 a second Gaussian mixture model based on a vector embedding of an updated training data set for the machine learning model, wherein the vector embedding of the updated training data set comprises the vector embedding of the training data set and a vector embedding of additional training data. The second Gaussian mixture model may be generated 704 using similar approaches as are set forth above with respect to the first Gaussian mixture model, differing in that the second Gaussian mixture model is based on a vector embedding of an updated training data set. This updated training data set includes the training data set used to train the machine learning model as well as additional training data that may be used to fine-tune the machine learning model. Thus, the vector encoding of the updated training data set will include the vector embedding of the training data set and a vector embedding of the additional training data. As will be described in further detail below, in some embodiments, the set of data points used to generate 704 the second Gaussian mixture model may also include derivative vectors generated based on the training data set and the additional training data.

The method of FIG. 7 also includes fine-tuning 706 the machine learning model using the additional training data based on a comparison of multiple parameters of the first Gaussian mixture model to multiple parameters of the second Gaussian mixture model. The first and second Gaussian mixture models each include multiple component normal distributions that themselves each include their own set of parameters. Such parameters may include, for example, a mean, a covariance matrix, or a mixture coefficient. Thus, the first and second Gaussian mixture models each include a set of multiple parameters.

The comparison of multiple parameters of the first Gaussian mixture model to multiple parameters of the second Gaussian mixture model reflects the degree to which the multiple parameters change between the first and second Gaussian mixture models. The particular parameters to be compared may include all of the parameters of the Gaussian mixture models or a subset thereof. For example, the parameters to be compared may include the means, the covariance matrices, and/or the mixture coefficients.

As will be described in further detail below, fine-tuning 706 the machine learning model using the additional training data based on a comparison of multiple parameters of the first Gaussian mixture model to multiple parameters of the second Gaussian mixture model may be performed using a variety of approaches. For example, in some embodiments, a degree of change in the compared parameters may be calculated. Where this degree of change exceeds some tolerance threshold, fine-tuning of the machine learning model may be automatically initiated. As another example, a visualization such as a chromatograph depicting the changes in compared parameters may be presented for a user that may then initiate fine-tuning of the machine learning model based on the presented visualization.

The approaches set forth above allow for fine-tuning to be initiated when changes in the parameters of Gaussian mixture models based on a training data set and an updated training data set indicate a significant change across these two data sets. This may prevent fine-tuning a model too early, costing money, time, and resources, and may prevent fine-tuning a model too late, causing a deployed model to lag behind competitors or grow stale, improving the overall user experience and system utility while reducing overall resource expenditure.

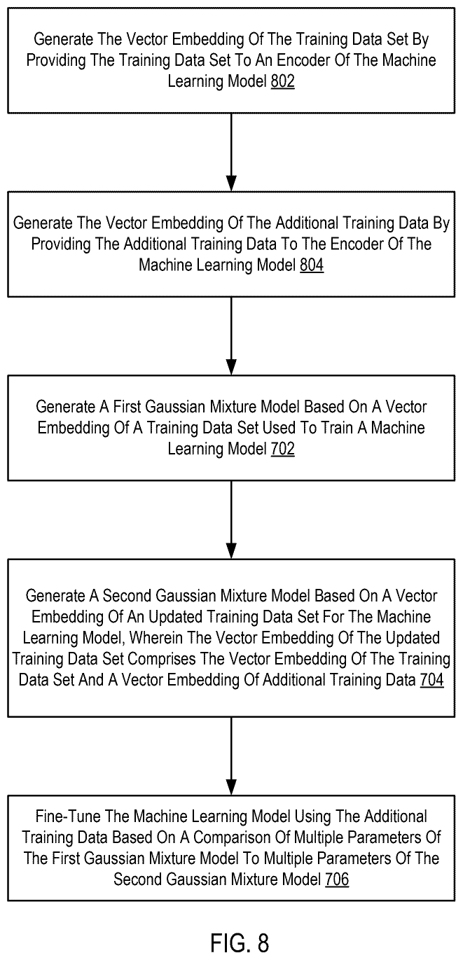

FIG. 8 sets forth a flowchart of another example method of evaluating fine-tuning of machine learning models based on training data distributions in accordance with some embodiments of the present disclosure. The method of FIG. 8 is similar to FIG. 7 in that the method of FIG. 8 also includes: generating 702 a first Gaussian mixture model based on a vector embedding of a training data set used to train a machine learning model; generating 704 a second Gaussian mixture model based on a vector embedding of an updated training data set for the machine learning model, wherein the vector embedding of the updated training data set comprises the vector embedding of the training data set and a vector embedding of additional training data; and fine-tuning 706 the machine learning model using the additional training data based on a comparison of multiple parameters of the first Gaussian mixture model to multiple parameters of the second Gaussian mixture model.

The method of FIG. 8 differs from FIG. 7 in that the method of FIG. 8 also includes generating 802 the vector embedding of the training data set by providing the training data set to an encoder of the machine learning model. In some embodiments, the machine learning model may be implemented using an encoder-decoder architecture. Thus, the machine learning model may include an encoder component that accepts input data and provides, as output, a vector embedding of that input data. Accordingly, this encoder component may be used to generate 802 the vector embedding of the training data set by providing each sample in the training data set as input to the encoder to generate a corresponding vector embedding.

The method of FIG. 8 further differs from FIG. 7 in that the method of FIG. 8 also includes generating 804 the vector embedding of the additional training data by providing the additional training data to the encoder of the machine learning model. The vector embedding of the training data may then be combined with the vector embedding of the additional training data to form the vector embedding of the updated training data set used in generating 704 the second Gaussian mixture model as described above.

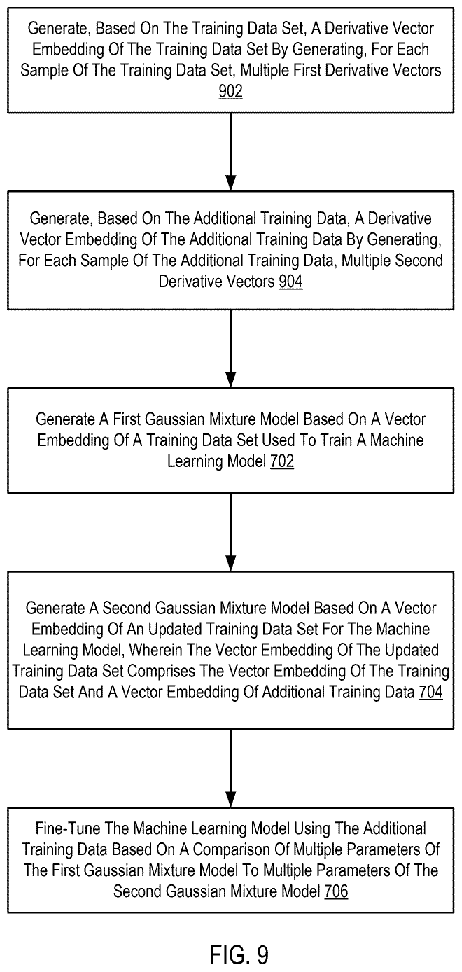

FIG. 9 sets forth a flowchart of another example method of evaluating fine-tuning of machine learning models based on training data distributions in accordance with some embodiments of the present disclosure. The method of FIG. 9 is similar to FIG. 7 in that the method of FIG. 9 also includes: generating 702 a first Gaussian mixture model based on a vector embedding of a training data set used to train a machine learning model; generating 704 a second Gaussian mixture model based on a vector embedding of an updated training data set for the machine learning model, wherein the vector embedding of the updated training data set comprises the vector embedding of the training data set and a vector embedding of additional training data; and fine-tuning 706 the machine learning model using the additional training data based on a comparison of multiple parameters of the first Gaussian mixture model to multiple parameters of the second Gaussian mixture model.

The method of FIG. 9 differs from FIG. 7 in that the method of FIG. 9 also includes generating 902, based on the training data set, a derivative vector embedding of the training data set by generating, for each sample the training data set, multiple first derivative vectors. In other words, for each sample in the training data set, multiple, different derivative vectors may be generated. As each vector in the vector embedding of the training data set may represent a point in multidimensional space, the addition of derivative vectors serves to add clusters or distributions of additional data points to the vector embedding of the training data set.

The method of FIG. 9 also includes generating 904, based on the additional training data, a derivative vector embedding of the additional training data by generating, for each sample of the additional training data, multiple second derivative vectors. The derivative vector embedding of the additional training data may be generated according to similar approaches as the derivative vector embedding of the training data. For example, in some embodiments, multiple derivative vectors may be generated from each sample of the additional training data.

The first Gaussian mixture model may then be generated 702 using a data set that includes both the vector embedding of the training data and the derivative vector embedding of the training data. The second Gaussian mixture model may then be generated 702 using another data set that includes the updated training data set (e.g., the training data and the additional training data) and a derivative vector embedding of the updated training data set (e.g., the derivative vector embeddings of the training data and the additional training data). Including these additional data points (e.g., in the derivative vector embeddings) to the data sets used to generate the Gaussian mixture models increases the overall density of data points as distributed across the data sets. This allows for the algorithms used in generating the Gaussian mixture models to more accurately converge and reflect their underlying data.

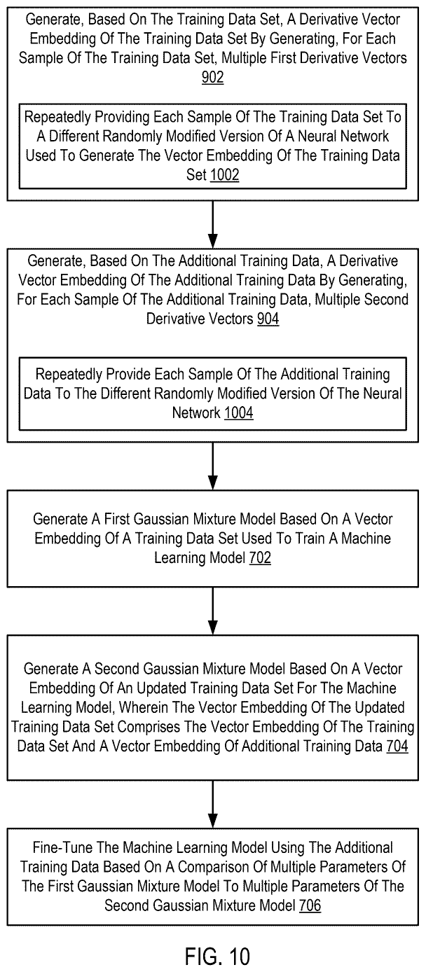

FIG. 10 sets forth a flowchart of another example method of evaluating fine-tuning of machine learning models based on training data distributions in accordance with some embodiments of the present disclosure. The method of FIG. 10 is similar to FIG. 9 in that the method of FIG. 10 also includes: generating 902, based on the training data set, a derivative vector embedding of the training data set by generating, for each sample the training data set, multiple first derivative vectors; based on the additional training data, a derivative vector embedding of the additional training data by generating, for each sample of the additional training data, multiple second derivative vectors; generating 702 a first Gaussian mixture model based on a vector embedding of a training data set used to train a machine learning model; generating 704 a second Gaussian mixture model based on a vector embedding of an updated training data set for the machine learning model, wherein the vector embedding of the updated training data set comprises the vector embedding of the training data set and a vector embedding of additional training data; and fine-tuning 706 the machine learning model using the additional training data based on a comparison of multiple parameters of the first Gaussian mixture model to multiple parameters of the second Gaussian mixture model.

The method of FIG. 10 differs from FIG. 9 in that generating 902, based on the training data set, a derivative vector embedding of the training data set by generating, for each sample the training data set, multiple first derivative vectors also includes repeatedly providing 1002 providing each sample of the training data set to a different randomly modified version of a neural network used to generate the vector embedding of the training data set. The method of FIG. 10 further differs from FIG. 9 in that based on the additional training data, a derivative vector embedding of the additional training data by generating, for each sample of the additional training data, multiple second derivative vectors also includes repeatedly providing 1004 repeatedly providing each sample of the additional training data to the different randomly modified version of the neural network. In other words, to generate each derivative vector, its source sample (e.g., of training data or additional training data) may be provided as input to a version of the neural network used to generate the vector embeddings that has been randomly modified. This allows for the derivative vectors to be consistent in the multidimensional space with respect to the vectors generated from the same data point. For example, the neural network to be randomly modified may include an encoder of the machine learning model.

For example, a neural network may be randomly modified by randomly removing some number of neural connections in the neural network. This may include generating, for each neural connection, a random number and comparing that random number to a probability threshold. This probability threshold may correspond to a percentage of neural connections to be removed in the modified neural network. Thus, the modified neural network may include a percentage of removed neural connections approximately matching the probability threshold.

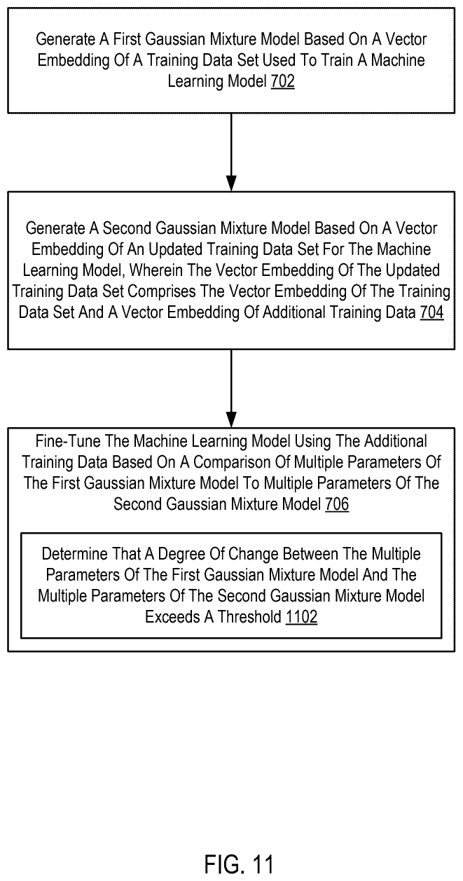

FIG. 11 sets forth a flowchart of another example method of evaluating fine-tuning of machine learning models based on training data distributions in accordance with some embodiments of the present disclosure. The method of FIG. 11 is similar to FIG. 7 in that the method of FIG. 11 also includes: generating 702 a first Gaussian mixture model based on a vector embedding of a training data set used to train a machine learning model; generating 704 a second Gaussian mixture model based on a vector embedding of an updated training data set for the machine learning model, wherein the vector embedding of the updated training data set comprises the vector embedding of the training data set and a vector embedding of additional training data; and fine-tuning 706 the machine learning model using the additional training data based on a comparison of multiple parameters of the first Gaussian mixture model to multiple parameters of the second Gaussian mixture model.

The method of FIG. 11 differs from FIG. 7 in that fine-tuning 706 the machine learning model using the additional training data based on a comparison of multiple parameters of the first Gaussian mixture model to multiple parameters of the second Gaussian mixture model also includes determining 1102 that a degree of change between the multiple parameters of the first Gaussian mixture model and the multiple parameters of the second Gaussian mixture model exceeds a threshold. In some embodiments, a degree of change between the parameters of the first Gaussian mixture model (e.g., either all parameters or a subset thereof) and the corresponding parameters of the second Gaussian mixture model may be calculated. For example, the parameters of the first and second Gaussian mixture models may each be mapped to points in multidimensional space. The degree of change may then be calculated as a distance between these multidimensional points. This degree of change may then be compared to some predefined, configurable, or user-defined tolerance threshold. Where the degree of change exceeds this threshold, fine-tuning of the machine learning model using the additional training data may be initiated.

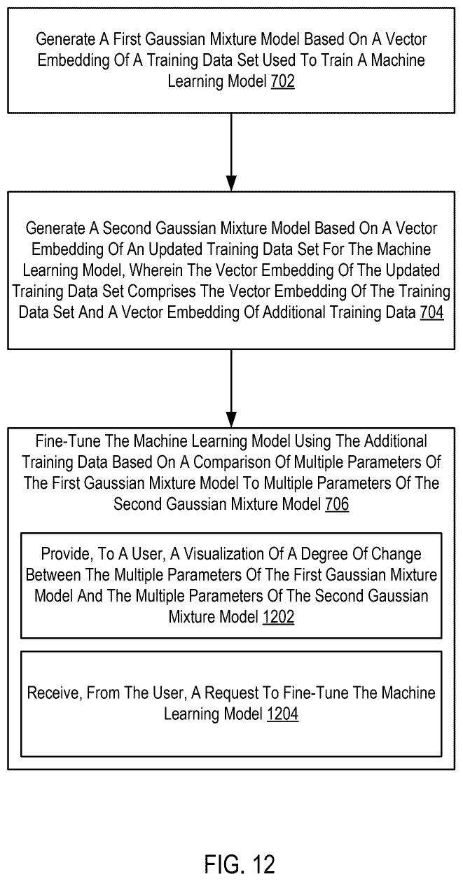

FIG. 12 sets forth a flowchart of another example method of evaluating fine-tuning of machine learning models based on training data distributions in accordance with some embodiments of the present disclosure. The method of FIG. 12 is similar to FIG. 7 in that the method of FIG. 12 also includes: generating 702 a first Gaussian mixture model based on a vector embedding of a training data set used to train a machine learning model; generating 704 a second Gaussian mixture model based on a vector embedding of an updated training data set for the machine learning model, wherein the vector embedding of the updated training data set comprises the vector embedding of the training data set and a vector embedding of additional training data; and fine-tuning 706 the machine learning model using the additional training data based on a comparison of multiple parameters of the first Gaussian mixture model to multiple parameters of the second Gaussian mixture model.

The method of FIG. 12 differs from FIG. 7 in that fine-tuning 706 the machine learning model using the additional training data based on a comparison of multiple parameters of the first Gaussian mixture model to multiple parameters of the second Gaussian mixture model also includes providing 1202, to a user, a visualization of a degree of change between the multiple parameters of the first Gaussian mixture model and the multiple parameters of the second Gaussian mixture model. In some embodiments, this visualization may include a graph of the components of the second Gaussian mixture model such as a graph of their respective normal distributions (e.g., as a line graph or other graph). In some embodiments, this visualization be a chromatograph with changes in color reflecting differences between the multiple parameters of the first and second Gaussian mixture model. For example, the color used to represent each component may be based on a degree of change of a particular component between the first and second Gaussian mixture models. As another example, a saturation of the color used to represent each component may be based on a degree of change of another particular component between the first and second Gaussian mixture models.

The method of FIG. 12 further differs from FIG. 7 in that fine-tuning 706 the machine learning model using the additional training data based on a comparison of multiple parameters of the first Gaussian mixture model to multiple parameters of the second Gaussian mixture model also includes receiving 1204, from the user, a request to fine-tune the machine learning model. In some embodiments, this request may be received as a command or other input to a user interface (e.g., a GUI) presenting the visualization. In some embodiments, this request may be received as a command or input to some other interface such as another GUI, a command line interface, and the like. Thus, the visualization serves to inform a user as to how the parameters of each component change between the first and second Gaussian mixture models, allowing the user to determine whether to initiate a fine-tuning of the machine learning model.

Readers will appreciate that, although the approaches set forth herein are described with respect to fine-tuning a machine learning model based on some additional training data, these approaches may also be used for determining when to initiate a full retraining of the machine learning model using both the original training data and the additional training data. Moreover, although the approaches set forth herein describe comparing parameters between different Gaussian mixture models, the approaches set forth herein may also be used in comparing the parameters of other mixture models of data. For example, while generating Gaussian mixture models is a hyperparametric approach that requires, as a hyperparameter, a number of components for the resulting model, the are the approaches set forth herein may also be applied to comparing parameters for non-hyperparametric mixture models such as a Dirichlet Process Mixture Model (DPMM) that does not require a predefined number of components, and instead dynamically infers a number of components in the resultant distribution.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
generating a first Gaussian mixture model based on a vector embedding of a training data set used to train a machine learning model;
generating a second Gaussian mixture model based on a vector embedding of an updated training data set for the machine learning model, wherein the vector embedding of the updated training data set comprises the vector embedding of the training data set and a vector embedding of additional training data; and
fine-tuning the machine learning model using the additional training data based on a comparison of multiple parameters of the first Gaussian mixture model to multiple parameters of the second Gaussian mixture model.

2. The computer-implemented method of claim 1, further comprising:
generating the vector embedding of the training data set by providing the training data set to an encoder of the machine learning model; and
generating the vector embedding of the additional training data by providing the additional training data to the encoder of the machine learning model.

3. The computer-implemented method of claim 1, further comprising:
generating, based on the training data set, a derivative vector embedding of the training data set by generating, for each sample of the training data set, multiple first derivative vectors;
generating, based on the additional training data, a derivative vector embedding of the additional training data by generating, for each sample of the additional training data, multiple second derivative vectors; and
wherein the first Gaussian mixture model is based on the derivative vector embedding of the training data set and the second Gaussian mixture model is based on a derivative vector embedding of the updated training data set comprising the derivative vector embedding of the training data set and the derivative vector embedding of the additional training data.

4. The computer-implemented method of claim 3:
wherein generating, for each sample of the training data set, multiple first derivative vectors comprises repeatedly providing each sample of the training data set to a different randomly modified version of a neural network used to generate the vector embedding of the training data set; and
wherein generating, for each sample of the additional training data, multiple second derivative vectors comprises repeatedly providing each sample of the additional training data to the different randomly modified version of the neural network.

5. The computer-implemented method of claim 1, wherein the multiple parameters of the first Gaussian mixture model and the multiple parameters of the second Gaussian mixture model each comprise: corresponding multiple means, corresponding multiple covariance matrices, or corresponding multiple mixture coefficients.

6. The computer-implemented method of claim 1, wherein fine-tuning the machine learning model using the additional training data based on the comparison of the multiple parameters of the first Gaussian mixture model to the multiple parameters of the second Gaussian mixture model comprises determining that a degree of change between the multiple parameters of the first Gaussian mixture model and the multiple parameters of the second Gaussian mixture model exceeds a threshold.

7. The computer-implemented method of claim 1, wherein fine-tuning the machine learning model using the additional training data based on the comparison of the multiple parameters of the first Gaussian mixture model to the multiple parameters of the second Gaussian mixture model comprises:
providing, to a user, a visualization of a degree of change between the multiple parameters of the first Gaussian mixture model and the multiple parameters of the second Gaussian mixture model; and
receiving, from the user, a request to fine-tune the machine learning model.

8. A computer system comprising:
a processor set;
one or more computer-readable storage media; and
program instructions stored on the one or more storage media to cause the processor set to perform operations comprising:
generating a first Gaussian mixture model based on a vector embedding of a training data set used to train a machine learning model;
generating a second Gaussian mixture model based on a vector embedding of an updated training data set for the machine learning model, wherein the vector embedding of the updated training data set comprises the vector embedding of the training data set and a vector embedding of additional training data; and
fine-tuning the machine learning model using the additional training data based on a comparison of multiple parameters of the first Gaussian mixture model to multiple parameters of the second Gaussian mixture model.

9. The computer system of claim 8, wherein the operations further comprise:
generating the vector embedding of the training data set by providing the training data set to an encoder of the machine learning model; and
generating the vector embedding of the additional training data by providing the additional training data to the encoder of the machine learning model.

10. The computer system of claim 8, wherein the operations further comprise:
generating, based on the training data set, a derivative vector embedding of the training data set by generating, for each sample of the training data set, multiple first derivative vectors;
generating, based on the additional training data, a derivative vector embedding of the additional training data by generating, for each sample of the additional training data, multiple second derivative vectors; and
wherein the first Gaussian mixture model is based on the derivative vector embedding of the training data set and the second Gaussian mixture model is based on a derivative vector embedding of the updated training data set comprising the derivative vector embedding of the training data set and the derivative vector embedding of the additional training data.

11. The computer system of claim 10:
wherein generating, for each sample of the training data set, multiple first derivative vectors comprises repeatedly providing each sample of the training data set to a different randomly modified version of a neural network used to generate the vector embedding of the training data set; and
wherein generating, for each sample of the additional training data, multiple second derivative vectors comprises repeatedly providing each sample of the additional training data to the different randomly modified version of the neural network.

12. The computer system of claim 8, wherein the multiple parameters of the first Gaussian mixture model and the multiple parameters of the second Gaussian mixture model each comprise: corresponding multiple means, corresponding multiple covariance matrices, or corresponding multiple mixture coefficients.

13. The computer system of claim 8, wherein fine-tuning the machine learning model using the additional training data based on the comparison of the multiple parameters of the first Gaussian mixture model to the multiple parameters of the second Gaussian mixture model comprises determining that a degree of change between the multiple parameters of the first Gaussian mixture model and the multiple parameters of the second Gaussian mixture model exceeds a threshold.

14. The computer system of claim 8, wherein fine-tuning the machine learning model using the additional training data based on the comparison of the multiple parameters of the first Gaussian mixture model to the multiple parameters of the second Gaussian mixture model comprises:
providing, to a user, a visualization of a degree of change between the multiple parameters of the first Gaussian mixture model and the multiple parameters of the second Gaussian mixture model; and
receiving, from the user, a request to fine-tune the machine learning model.

15. A computer program product comprising:
one or more computer readable storage media; and
program instructions stored on the one or more storage media to perform operations comprising:
generating a first Gaussian mixture model based on a vector embedding of a training data set used to train a machine learning model;
generating a second Gaussian mixture model based on a vector embedding of an updated training data set for the machine learning model, wherein the vector embedding of the updated training data set comprises the vector embedding of the training data set and a vector embedding of additional training data; and
fine-tuning the machine learning model using the additional training data based on a comparison of multiple parameters of the first Gaussian mixture model to multiple parameters of the second Gaussian mixture model.

16. The computer program product of claim 15, wherein the operations further comprise:
generating the vector embedding of the training data set by providing the training data set to an encoder of the machine learning model; and
generating the vector embedding of the additional training data by providing the additional training data to the encoder of the machine learning model.

17. The computer program product of claim 15, wherein the operations further comprise:
generating, based on the training data set, a derivative vector embedding of the training data set by generating, for each sample of the training data set, multiple first derivative vectors;
generating, based on the additional training data, a derivative vector embedding of the additional training data by generating, for each sample of the additional training data, multiple second derivative vectors; and
wherein the first Gaussian mixture model is based on the derivative vector embedding of the training data set and the second Gaussian mixture model is based on a derivative vector embedding of the updated training data set comprising the derivative vector embedding of the training data set and the derivative vector embedding of the additional training data.

18. The computer program product of claim 17:
wherein generating, for each sample of the training data set, multiple first derivative vectors comprises repeatedly providing each sample of the training data set to a different randomly modified version of a neural network used to generate the vector embedding of the training data set; and
wherein generating, for each sample of the additional training data, multiple second derivative vectors comprises repeatedly providing each sample of the additional training data to the different randomly modified version of the neural network.

19. The computer program product of claim 15, wherein the multiple parameters of the first Gaussian mixture model and the multiple parameters of the second Gaussian mixture model each comprise: corresponding multiple means, corresponding multiple covariance matrices, or corresponding multiple mixture coefficients.

20. The computer program product of claim 15, wherein fine-tuning the machine learning model using the additional training data based on the comparison of the multiple parameters of the first Gaussian mixture model to the multiple parameters of the second Gaussian mixture model comprises determining that a degree of change between the multiple parameters of the first Gaussian mixture model and the multiple parameters of the second Gaussian mixture model exceeds a threshold.
